(19) United States
(12) Patent Application Publication
(10) Pub. No.: US 2013/0056128 A1
(43) Pub. Date: Mar. 7, 2013

(54) PNEUMATIC TIRE WITH CONDUCTIVE BLEEDER CORDS

(71) Applicants: Carlo Kanz, Mamer (LU); Christian Jean-Marie Kaes, Schrondweiler (LU); Olivio Jean-Baptiste Pagliarini, Consdorf (LU); Raphael Beck, Reichlange (LU)

(72) Inventors: Carlo Kanz, Mamer (LU); Christian Jean-Marie Kaes, Schrondweiler (LU); Olivio Jean-Baptiste Pagliarini, Consdorf (LU); Raphael Beck, Reichlange (LU)

(21) Appl. No.: 13/225,657

(22) Filed: Sep. 6, 2011

(51) Int. Cl. B60C 9/02

(52) U.S. Cl. 152/548

(57) ABSTRACT

A carcass ply for a pneumatic tire in accordance with the present invention includes a plurality of load bearing cords calendered within a polymer matrix and a plurality of gas bleeder cords for moving gas away from an interface of the load bearing cords and the polymer matrix. The plurality of gas bleeder cords also function to conduct electrical charge from a belt structure of the pneumatic tire to a bead portion of the pneumatic tire.

### FIELD OF INVENTION

The present invention relates to pneumatic tires and, more particularly, to cords in a pneumatic tire that both bleed air and conduct electricity.

### BACKGROUND OF THE INVENTION

In the curing of a pneumatic tire, the presence of air or other compressible gases within the body of the tire being cured may cause defects which are known as blows or blisters. These defects may involve local separation between the rubber and one or more of the reinforcement cords which make up the reinforcing ply of a pneumatic tire. Air may become trapped in or between the layers of materials which are superimposed in the course of building the tire or may in some instances enter into the tire during the time lapse between the building of the tire and the placing of the tire into a mold in which it will be cured. Further, small quantities of air may be forced into the body of the uncured tire by the closing of the mold.

Conventional tire reinforcement cords may contain passages extending generally throughout the length of the cord, lying between and bounded by the filaments which make up the cords, and that air or other gases may travel along such passages. It has been observed that the treatment of tire reinforcement cords such as stretching of heated cords, for example cords made of continuous synthetic resin filament materials such as polyester and nylon, may significantly reduce the cross sectional area of the interfilamentary passages. Stretching of heated cords may result in a reduction of a cross sectional area of the individual filaments and a compacting of the filaments more closely to one another.

During the time that the tire is being vulcanized by the application of heat and pressure thereto, any air trapped within the tire or any gases generated during the vulcanization of the tire may be sufficient in volume to prevent the development of a satisfactory bond between the rubber material and the reinforcing cords within the tire or may break such bonds by forcing a separation between the rubber and the reinforcement cords. The resulting defects are known as blisters or blows.

A heretofore unrelated issue is the increasing demand for low rolling resistance tires. The fact that quality and quantity of filler are typically modified in the carcass components to reduce hysteresis may produce tires that are borderline, or unacceptable, with regard to electrical conductivity

### DEFINITIONS

The following definitions are controlling for the present invention.

“Apex” means an elastomeric filler located radially above the bead core and between the plies and the turnup ply.

“Annular” means formed like a ring.

“Aspect ratio” means the ratio of its section height to its section width.

“Asymmetric tread” means a tread that has a tread pattern not symmetrical about the centerplane or equatorial plane EP of the tire.

“Axial” and “axially” are used herein to refer to lines or directions that are parallel to the axis of rotation of the tire.

“Bead” means that part of the tire comprising an annular tensile member wrapped by ply cords and shaped, with or without other reinforcement elements such as flippers, chippers, apexes, toe guards and chafers, to fit the design rim.

“Belt structure” means at least two annular layers or plies of parallel cords, woven or unwoven, underlying the tread, unanchored to the bead, and having cords inclined respect to the equatorial plane of the tire. The belt structure may also include plies of parallel cords inclined at relatively low angles, acting as restricting layers.

“Bias tire” (cross ply) means a tire in which the reinforcing cords in the carcass ply extend diagonally across the tire from bead to bead at about a 25° to 65° angle with respect to equatorial plane of the tire. If multiple plies are present, the ply cords run at opposite angles in alternating layers.

“Breakers” means at least two annular layers or plies of parallel reinforcement cords having the same angle with reference to the equatorial plane of the tire as the parallel reinforcing cords in carcass plies. Breakers are usually associated with bias tires.

“Cable” means a cord formed by twisting together two or more plied yarns.

“Carcass” means the tire structure apart from the belt structure, tread, undertread, and sidewall rubber over the plies, but including the beads.

“Casing” means the carcass, belt structure, beads, sidewalls and all other components of the tire excepting the tread and undertread, i.e., the whole tire.

“Chipper” refers to a narrow band of fabric or steel cords located in the bead area whose function is to reinforce the bead area and stabilize the radially inwardmost part of the sidewall.

“Circumferential” means lines or directions extending along the perimeter of the surface of the annular tire parallel to the Equatorial Plane (EP) and perpendicular to the axial direction; it can also refer to the direction of the sets of adjacent circular curves whose radii define the axial curvature of the tread, as viewed in cross section.

“Cord” means one of the reinforcement strands of which the reinforcement structures of the tire are comprised.

“Cord angle” means the acute angle, left or right in a plan view of the tire, formed by a cord with respect to the equatorial plane. The “cord angle” is measured in a cured but uninflated tire.

“Crown” means that portion of the tire within the width limits of the tire tread.

“Denier” means the weight in grams per 9000 meters (unit for expressing linear density). “Dtex” means the weight in grams per 10,000 meters.

“Density” means weight per unit length.

“Elastomer” means a resilient material capable of recovering size and shape after deformation.

“Equatorial plane (EP)” means the plane perpendicular to the tire's axis of rotation and passing through the center of its tread; or the plane containing the circumferential centerline of the tread.

“Fabric” means a network of essentially unidirectionally extending cords, which may be twisted, and which in turn are composed of a plurality of a multiplicity of filaments (which may also be twisted) of a high modulus material.

“Fiber” is a unit of matter, either natural or man-made that forms the basic element of filaments. Characterized by having a length at least 100 times its diameter or width.

“Filament count” means the number of filaments that make up a yarn. Example: 1000 denier polyester has approximately 190 filaments.

“Flipper” refers to a reinforcing fabric around the bead wire for strength and to tie the bead wire in the tire body.

“Footprint” means the contact patch or area of contact of the tire tread with a flat surface at zero speed and under normal load and pressure.

“Gauge” refers generally to a measurement, and specifically to a thickness measurement.

“Groove” means an elongated void area in a tread that may extend circumferentially or laterally about the tread in a straight, curved, or zigzag manner. Circumferentially and laterally extending grooves sometimes have common portions. The “groove width” may be the tread surface occupied by a groove or groove portion divided by the length of such groove or groove portion; thus, the groove width may be its average width over its length. Grooves may be of varying depths in a tire. The depth of a groove may vary around the circumference of the tread, or the depth of one groove may be constant but vary from the depth of another groove in the tire. If such narrow or wide grooves are of substantially reduced depth as compared to wide circumferential grooves, which they interconnect, they may be regarded as forming “tie bars” tending to maintain a rib-like character in the tread region involved. As used herein, a groove is intended to have a width large enough to remain open in the tires contact patch or footprint.

“High Tensile Steel (HT)” means a carbon steel with a tensile strength of at least 3400 MPa at 0.20 mm filament diameter.

“Inner” means toward the inside of the tire and “outer” means toward its exterior.

“Innerliner” means the layer or layers of elastomer or other material that form the inside surface of a tubeless tire and that contain the inflating fluid within the tire.

“Inboard side” means the side of the tire nearest the vehicle when the tire is mounted on a wheel and the wheel is mounted on the vehicle.

“LASE” is load at specified elongation.

“Lateral” means an axial direction.

“Lay length” means the distance at which a twisted filament or strand travels to make a 360 degree rotation about another filament or strand.

“Load Range” means load and inflation limits for a given tire used in a specific type of service as defined by tables in The Tire and Rim Association, Inc.

“Mega Tensile Steel (MT)” means a carbon steel with a tensile strength of at least 4500 MPa at 0.20 mm filament diameter.

“Net contact area” means the total area of ground contacting elements between defined boundary edges divided by the gross area between the boundary edges as measured around the entire circumference of the tread.

“Net-to-gross ratio” means the total area of ground contacting tread elements between lateral edges of the tread around the entire circumference of the tread divided by the gross area of the entire circumference of the tread between the lateral edges.

“Non-directional tread” means a tread that has no preferred direction of forward travel and is not required to be positioned on a vehicle in a specific wheel position or positions to ensure that the tread pattern is aligned with the preferred direction of travel. Conversely, a directional tread pattern has a preferred direction of travel requiring specific wheel positioning.

“Normal Load” means the specific design inflation pressure and load assigned by the appropriate standards organization for the service condition for the tire.

“Normal Tensile Steel (NT)” means a carbon steel with a tensile strength of at least 2800 MPa at 0.20 mm filament diameter.

“Outboard side” means the side of the tire farthest away from the vehicle when the tire is mounted on a wheel and the wheel is mounted on the vehicle.

“Ply” means a cord-reinforced layer of rubber-coated radially deployed or otherwise parallel cords.

“Radial” and “radially” are used to mean directions radially toward or away from the axis of rotation of the tire.

“Radial Ply Structure” means the one or more carcass plies or which at least one ply has reinforcing cords oriented at an angle of between 65° and 90° with respect to the equatorial plane of the tire.

“Radial Ply Tire” means a belted or circumferentially-restricted pneumatic tire in which at least one ply has cords which extend from bead to bead are laid at cord angles between 65° and 90° with respect to the equatorial plane of the tire.

“Rib” means a circumferentially extending strip of rubber on the tread which is defined by at least one circumferential groove and either a second such groove or a lateral edge, the strip being laterally undivided by full-depth grooves.

“Rivet” means an open space between cords in a layer.

“Section Height” means the radial distance from the nominal rim diameter to the outer diameter of the tire at its equatorial plane.

“Section Width” means the maximum linear distance parallel to the axis of the tire and between the exterior of its sidewalls when and after it has been inflated at normal pressure for 24 hours, but unloaded, excluding elevations of the sidewalls due to labeling, decoration or protective bands.

“Self-supporting run-flat” means a type of tire that has a structure wherein the tire structure alone is sufficiently strong to support the vehicle load when the tire is operated in the uninflated condition for limited periods of time and limited speed. The sidewall and internal surfaces of the tire may not collapse or buckle onto themselves due to the tire structure alone (e.g., no internal structures).

“Sidewall insert” means elastomer or cord reinforcements located in the sidewall region of a tire. The insert may be an addition to the carcass reinforcing ply and outer sidewall rubber that forms the outer surface of the tire.

“Sidewall” means that portion of a tire between the tread and the bead.

“Sipe” or “incision” means small slots molded into the tread elements of the tire that subdivide the tread surface and improve traction; sipes may be designed to close when within the contact patch or footprint, as distinguished from grooves.

“Spring Rate” means the stiffness of tire expressed as the slope of the load deflection curve at a given pressure.

“Stiffness ratio” means the value of a control belt structure stiffness divided by the value of another belt structure stiffness when the values are determined by a fixed three point bending test having both ends of the cord supported and flexed by a load centered between the fixed ends.

“Super Tensile Steel (ST)” means a carbon steel with a tensile strength of at least 3650 MPa at 0.20 mm filament diameter.

“Tenacity” is stress expressed as force per unit linear density of the unstrained specimen (gm/tex or gm/denier). Used in textiles.

“Tensile” is stress expressed in forces/cross-sectional area. Strength in psi=12,800 times specific gravity times tenacity in grams per denier.

“Toe guard” refers to the circumferentially deployed elastomeric rim-contacting portion of the tire axially inward of each bead.

“Tread” means a molded rubber component which, when bonded to a tire casing, includes that portion of the tire that comes into contact with the road when the tire is normally inflated and under normal load.

“Tread element” or “traction element” means a rib or a block element.

“Tread width” means the arc length of the tread surface in a plane including the axis of rotation of the tire.

“Turnup end” means the portion of a carcass ply that turns upward (i.e., radially outward) from the beads about which the ply is wrapped.

“Ultra Tensile Steel (UT)” means a carbon steel with a tensile strength of at least 4000 MPa at 0.20 mm filament diameter.

“Vertical Deflection” means the amount that a tire deflects under load.

“Yarn” is a generic term for a continuous strand of textile fibers or filaments. Yarn occurs in the following forms: 1) a number of fibers twisted together; 2) a number of filaments laid together without twist; 3) a number of filaments laid together with a degree of twist; 4) a single filament with or without twist (monofilament); 5) a narrow strip of material with or without twist.

### SUMMARY OF THE INVENTION

A carcass ply for a pneumatic tire in accordance with the present invention includes a plurality of load bearing cords calendered within a polymer matrix and a plurality of gas bleeder cords for moving gas away from an interface of the load bearing cords and the polymer matrix. The plurality of gas bleeder cords also function to conduct electrical charge from a belt structure of the pneumatic tire to a bead portion of the pneumatic tire.

According to another aspect of the present invention, the load bearing cords are separate and distinct from the gas bleeder cords.

According to still another aspect of the present invention, the load bearing cords are arranged parallel to each other and to the gas bleeder cords.

According to yet another aspect of the present invention, the gas bleeder cords are laid on outer planar surfaces of the polymer matrix.

According to still another aspect of the present invention, the gas bleeder cords comprise an organic fiber core for performing the gas bleeder function and a metal filament sheath for performing the electrical conduction function.

According to yet another aspect of the present invention, the organic fiber cord is cotton and the metal filament is steel.

A pneumatic tire in accordance with the present invention includes two bead portions, a carcass ply extending between the bead portions, a belt structure disposed radially outward from the carcass ply, and a tread portion located radially outward from the carcass ply and belt structure. The carcass ply includes a plurality of load bearing cords calendered within a polymer matrix and a plurality of gas bleeder cords for moving gas away from an interface of the load bearing cords and the polymer matrix. The plurality of gas bleeder cords also function to conduct electrical charge from the belt structure to the bead portions.

According to another aspect of the present invention, the load bearing cords of the pneumatic are separate and distinct from the gas bleeder cords.

According to still another aspect of the present invention, the load bearing cords of the pneumatic tire are arranged parallel to each other and to the gas bleeder cords.

According to yet another aspect of the present invention, the gas bleeder cords of the pneumatic tire are laid on planar surfaces of the polymer matrix.

According to still another aspect of the present invention, the gas bleeder cords of the pneumatic tire include an organic fiber core for performing the gas bleeder function and a metal filament sheath for performing the electrical conduction function.

According to yet another aspect of the present invention, the organic fiber core is cotton and the metal filament sheath is steel.

According to still another aspect of the present invention, the load bearing cords are dipped in a conductive coat for performing the electrical conduction function.

### BRIEF DESCRIPTION OF THE DRAWINGS

The present invention will be described by way of example and with reference to the accompanying drawings in which:

FIG. 1 is a schematic cross-sectional view of an example pneumatic tire for use with the present invention.

FIG. 2 is a schematic perspective, partially cutaway, view of a tire reinforcement ply in accordance with the present invention.

FIG. 3 is a schematic detail view of a cord from FIG. 2.

### DESCRIPTION OF EXAMPLES IN THE PRESENT INVENTION

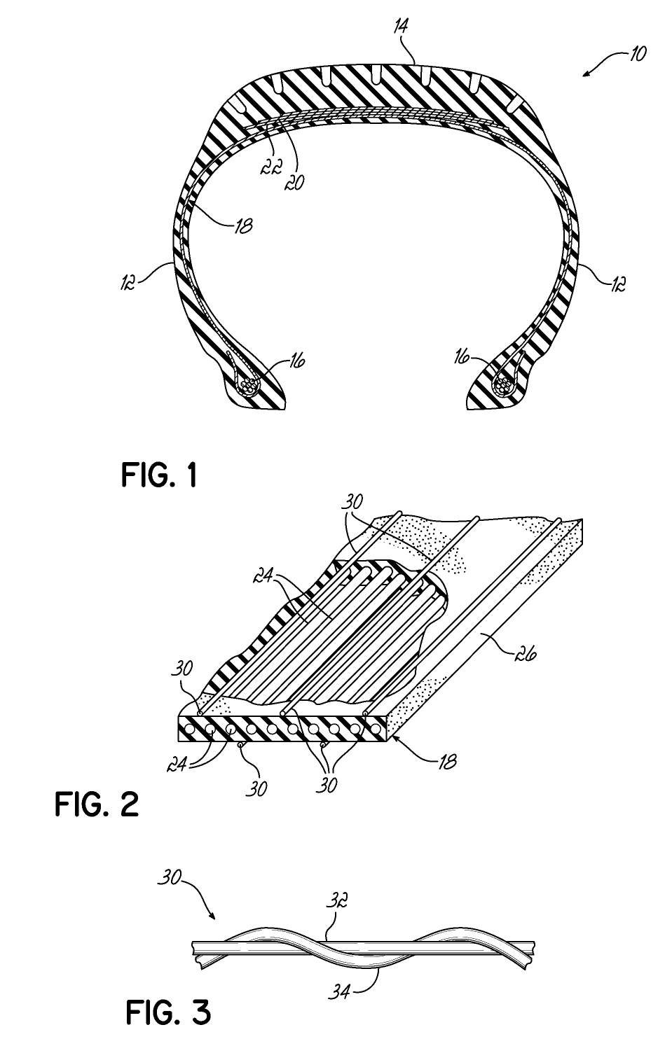

With reference to FIG. 1, a pneumatic tire 10 may include a pair of sidewall portions 12 terminating at their radially outer ends in a tread portion 14 and at their radially inner ends in a pair of beads 16. The tire 10 may further include at least one reinforcement ply 18 secured to each of the beads 16 and extending through the sidewall portions 12 of the tire and under the tread portion 14. The tire 10 may have one or more reinforcement plies 18, which are generally referred to as carcass plies. The tire 10 may also include additional reinforcing plies in the form of one or more breaker or belt plies 20, 22 disposed in the crown region of the tire 10 between the carcass ply 18 and the tread portion 14.

The tire 10 may have a bias, bias belted, or radial ply construction. In each case, the reinforcing ply 18 may be composed of a plurality of reinforcing cords extending in parallel spaced apart relation. In the case of a bias tire or bias belted construction, these reinforcing cords may extend at a suitable angle to the mid-circumferential center plane of the tire 10 at the circumferential centerline of the carcass ply 18, which angle may be, for example, from 25 to 40 degrees. In the case of a radial ply construction, the cords of the carcass ply 18 may extend substantially radially, for example, at an angle from 80 to 90 degrees to the mid-circumferential center plane of the tire 10.

The breaker or belt plies 20, 22 shown in FIG. 1 may each include a plurality of reinforcing cords extending in parallel spaced apart relation. The cords may extend at a relatively low angle, for example, 15 to 25 degrees when the belt plies 20, 22 are used in combination with a radial ply carcass and at a somewhat higher angle, perhaps 25 to 35 degrees when used in conjunction with a bias ply carcass either as a belt or as breaker plies. Where the breaker or belt plies 20, 22 are used in conjunction with a bias belted tire, the cords may have an angle at the mid-circumferential centerline of the tire 10 which is at least 5 degrees less than the corresponding angle of the carcass ply or plies 18, and where used as a breaker in conjunction with a bias tire may have an angle at the mid-circumferential centerline of the tire, which is equal or approximately equal to the corresponding angle of the carcass plies.

With reference to FIG. 2, there is shown a portion of an example ply 18 prior to the assembly of the ply into the tire 10. The ply 18 may comprise a plurality of reinforcing cords 24 disposed in parallel spaced apart relation and a plurality of conductive, bleeder cords 30 in accordance with the present invention. The conductive, bleeder cords 30 may be substantially parallel to the reinforcing cords 24 and lain on outer planar surfaces of a matrix of rubber or rubber-like polymer material 26 on both sides of the reinforcing cords 24. The reinforcing cords 24 may be calendered by passing the cords between rolls which press rubber 26 between the cords and coat the cords on both sides thereof with rubber or similar polymer. As will be seen from FIG. 2, each conductive, bleeder cord 30 may lie generally in a plane parallel to that defined by the reinforcing cords 24. The conductive, bleeder cords 30 may extend the full length of the reinforcing cords 24 (e.g., from radially under the belts 20, 22 to each bead 14). The conductive, bleeder cords 30 may thus conduct electrical charge from the belt structure 20, 22 to each bead 14. A conductive path may be defined by a conductive tread element, such as chimney, transferring electrical charge to a conductive tread base to the belt structure 20, 22 through the conductive, bleeder cords 30 to the beads 14 to a rim.

Thus, the conductive, bleeder cords 30 may provide a path for expulsion of air/gas through the tread portion 14 of the tire 10, and air/gas that is not expelled may be held/contained by the conductive, bleeder cords away from ply/rubber matrix interface. Each conductive, bleeder cord 30 may comprise a single yarn or a plurality of yarns/filaments, such as two yarns/filaments 32, 34 (FIG. 3) twisted together. The cords 30 may be a very low decitex cotton cord made electrically conductive by dipping the cords in a conductive coat. Alternatively, the cords 30 hay have a hybrid cord construction with a brass coated steel wire sheath or conductive fibres (e.g., conductive nano-material fibers twisted about a cotton fiber core). Such conductive, bleeder cords 30 may thus allow reduced hysteresis materials in skirt, sidewall, and ply components without reducing tire conductivity.

A yarn core 32 of the cords 30 may be composed of staple fibers selected from the group consisting of rayon, nylon, polyester, and/or glass for performing the air/gas bleed function of the cords. Such yarn 32 may not be intended to contribute to the reinforcement of the tire 10 and thus are not reinforcing cords. Each yarn 32 may have a breaking strength of between about one pound and two pounds, which may be no greater than one-fifth of the breaking strength of a reinforcing cord 24. A break strength of about one pound may be necessary to assure that the yarn 32 does not break, until necessary, under the usual tensions to which the yarns are subjected during manufacture of the reinforcing ply 18. A filament sheath 34 of the cords 30 may be composed of a steel wire coated with brass for performing the electrical conductivity function of the cords.

As stated above, a carcass ply 12 of cords 30 in accordance with the present invention produces excellent electrical conduction in a tire 10 as well as allowing use of harder, less conductive materials in other parts of the tire 10 for improved RR. This carcass ply 12 thus enhances the performance of the tire 10, even though the complexities of the structure and behavior of the pneumatic tire are such that no complete and satisfactory theory has been propounded. Temple, Mechanics of Pneumatic Tires (2005). While the fundamentals of classical composite theory are easily seen in pneumatic tire mechanics, the additional complexity introduced by the many structural components of pneumatic tires readily complicates the problem of predicting tire performance. Mayni, Composite Effects on Tire Mechanics (2005). Additionally, because of the non-linear time, frequency, and temperature behaviors of polymers and rubber, analytical design of pneumatic tires is one of the most challenging and underappreciated engineering challenges in today's industry. Mayni.

A pneumatic tire has certain essential structural elements. United States Department of Transportation, Mechanics of Pneumatic Tires, Pages 207 and 208 (1981). An important structural element is the carcass ply, typically made up of many flexible, high modulus cords of natural textile, synthetic polymer, glass fiber, or fine hard drawn steel embedded in, and bonded to, a matrix of low modulus polymeric material, usually natural or synthetic rubber. Id. at 207 through 208.

The flexible, high modulus cords are usually disposed as a single layer. Id. at 208. Tire manufacturers throughout the industry cannot agree or predict the effect of different twists of carcass ply cords on noise characteristics, handling, durability, comfort, etc. in pneumatic tires, Mechanics of Pneumatic Tires, Pages 80 through 85.

These complexities are demonstrated by the below table of the interrelationships between tire performance and tire components.

| | LINER | CARCASS PLY | APEX | BELT | OV'LY | TREAD | MOLD |
|---|---|---|---|---|---|---|---|
| TREADWEAR | | | | X | | X | X |
| NOISE | | X | X | X | X | X | X |
| HANDLING | | X | X | X | X | X | X |
| TRACTION | | | | | | X | X |
| DURABILITY | X | X | X | X | X | X | X |
| ROLL RESIST | X | | X | X | | X | X |
| RIDE COMFORT | X | X | X | | | X | |
| HIGH SPEED | | X | X | X | X | X | X |
| AIR RETENTION | X | | | | | | |
| MASS | X | X | X | X | X | X | X |

As seen in the table, carcass ply cord characteristics affect the other components of a pneumatic tire (i.e., carcass ply affects apex, belt, overlay, etc.), leading to a number of components interrelating and interacting in such a way as to affect a group of functional properties (noise, handling, durability, comfort, high speed, and mass), resulting in a completely unpredictable and complex composite. Thus, changing even one component can lead to directly improving or degrading as many as the above ten functional characteristics, as well as altering the interaction between that one component and as many as six other structural components. Each of those six interactions may thereby indirectly improve or degrade those ten functional characteristics. Whether each of these functional characteristics is improved, degraded, or unaffected, and by what amount, certainly would have been unpredictable without the experimentation and testing conducted by the inventors.

Thus, for example, when the structure (i.e., twist, cord construction, etc.) of the carcass ply cords of a pneumatic tire is modified with the intent to improve one functional property of the pneumatic tire, any number of other functional properties may be unacceptably degraded. Furthermore, the interaction between the carcass ply cords and the apex, belt, carcass, and tread may also unacceptably affect the functional properties of the pneumatic tire. A modification of the carcass ply cords may not even improve that one functional property because of these complex interrelationships.

Thus, as stated above, the complexity of the interrelationships of the multiple components makes the actual result of modification of a carcass ply, in accordance with the present invention, impossible to predict or foresee from the infinite possible results. Only through extensive experimentation have the carcass ply 12 and cords 30, 130 of the present invention been revealed as an excellent, unexpected, and unpredictable option for a tire carcass.

The previous descriptive language is of the best presently contemplated mode or modes of carrying out the present invention. This description is made for the purpose of illustrating an example of general principles of the present invention and should not be interpreted as limiting the present invention. The scope of the invention is best determined by reference to the appended claims. The reference numerals as depicted in the schematic drawings are the same as those referred to in the specification. For purposes of this application, the various examples illustrated in the figures each use a same reference numeral for similar components. The examples structures may employ similar components with variations in location or quantity thereby giving rise to alternative constructions in accordance with the present invention.

What is claimed is:

1. A carcass ply for a pneumatic tire comprising:
a plurality of load bearing cords calendered within a polymer matrix; and
a plurality of gas bleeder cords for moving gas away from an interface of the load bearing cords and the polymer matrix,
the plurality of gas bleeder cords also functioning to conduct electrical charge from a belt structure of the pneumatic tire to a bead portion of the pneumatic tire.

2. The carcass ply as set forth in claim 1 wherein the load bearing cords are separate and distinct from the gas bleeder cords.

3. The carcass ply as set forth in claim 1 wherein the load bearing cords are arranged parallel to each other and to the gas bleeder cords.

4. The carcass ply as set forth in claim 1 wherein the gas bleeder cords are laid on exterior surfaces of the polymer matrix.

5. The carcass ply as set forth in claim 1 wherein the gas bleeder cords comprise an organic fiber core for performing the gas bleeder function and a metal filament sheath for performing the electrical conduction function.

6. The carcass ply as set forth in claim 5 wherein the organic fiber core is cotton and the metal filament sheath is steel.

7. A pneumatic tire comprising:
two bead portions;
a carcass ply extending between the bead portions;
a belt structure disposed radially outward from the carcass ply; and
a tread portion located radially outward from the carcass ply and belt structure, the carcass ply comprising a plurality of load bearing cords calendered within a polymer matrix and a plurality of gas bleeder cords for moving gas away from an interface of the load bearing cords and the polymer matrix, the plurality of gas bleeder cords also functioning to conduct electrical charge from the belt structure to the bead portions.

8. The pneumatic tire as set forth in claim 7 wherein the load bearing cords are separate and distinct from the gas bleeder cords.

9. The pneumatic tire as set forth in claim 7 wherein the load bearing cords are arranged parallel to each other and to the gas bleeder cords.

10. The pneumatic tire as set forth in claim 7 wherein the gas bleeder cords are laid on outer surfaces of the polymer matrix.

11. The pneumatic tire as set forth in claim 7 wherein the gas bleeder cords comprise an organic fiber core for performing the gas bleeder function and a metal filament sheath for performing the electrical conduction function.

12. The pneumatic tire as set forth in claim 7 wherein the organic fiber core is cotton and the metal filament sheath is steel.

13. The pneumatic tire as set froth in claim 7 wherein the gas bleeder cords are dipped in a conductive coat for performing the electrical conduction function.
